(19) United States
(12) Patent Application Publication
(10) Pub. No.: US 2007/0015506 A1
(43) Pub. Date: Jan. 18, 2007

(54) Synchronization matrix process for total emergency management

(75) Inventors: Paul L. Hewett JR., Forest Hill, MD (US); Jacques E. Mitrani, Lemont, IL (US); William Christopher Metz, Chicago, IL (US); Christopher A. Jones, Morton Grove, IL (US); William C. Metz, Naperville, IL (US)

Correspondence Address: FOLEY & LARDNER LLP, 321 NORTH CLARK STREET, SUITE 2800, CHICAGO, IL, 60610-4764, US

(73) Assignee: Argonne National Laboratory

(21) Appl. No.: 11/182,567

(22) Filed: Jul. 15, 2005

(51) Int. Cl. H04Q 7/20

(52) U.S. Cl. 455/432.3

(57) ABSTRACT

A proactive and unifying systems-based method for total emergency management supported by an information technology architecture. The use of an embedded process for collaboration among a myriad of agencies fulfills newly recognized critical needs for interconnectivity and coordinated relationships among the public, private, nonprofit, and not-for-profit sectors in community preparedness, improved camaraderie among members of separate agencies, and a coordinated, integrated, and synchronized emergency response. Knowing and agreeing upon the actions that precede and succeed an integrating action among entities is the critical output of the synchronization matrix process for the present invention. The concept of tying these integrating actions to hazard actions and to decision points, so that timing of alert and notification, population protection, and response actions can be assessed against what needs to be initiated and when, serves to minimize community impacts from routine and catastrophic emergencies. A software tool implementing the present invention results in a collaborative set of relationship-centric activities (inter-agency planning) and a relationship-centric familiarization among participants (inter-agency coordination and camaraderie).

This invention was made with government support under Contract No. W-31-109-ENG-38 awarded to the Department of Energy. The Government has certain rights in this invention.

### FIELD OF THE INVENTION

The present invention relates generally to the planning and implementing of emergency responses to complex disasters. More particularly, the present invention relates to computer programs and processes for planning and implementing emergency responses to complex disasters that requires the rapid integration, coordination, and synchronization of multiple levels of organizations from numerous jurisdictions into a unified community response.

### BACKGROUND OF THE INVENTION

Terrorist attacks in the United States and Europe have generated a renewed desire for the rapid development of emergency response plans in order to be prepared for possible terrorist attacks involving chemical, biological, radiological, nuclear, high-yield explosive, and agriculture weapons of mass destruction. The current emphasis on written emergency plans, however, tends to divert attention from the process of planning itself, as well as the objective of achieving collaborative community emergency preparedness. It is known that the success of disaster response operations is substantially affected by the achievement of effective inter-organizational coordination among responding groups.

Emergency preparedness and response planning have always been the domain of local, state, and federal agencies. Governments have traditionally been responsible for developing plans for natural and technological hazards and responding to those hazards in emergencies. In some cases, the public and private sectors were included in emergency planning when required by government regulations.

Researchers now believe that the most visible long-term effect of the Sep. 11, 2001 terrorist attacks on the United States is more detailed attention to preparedness and a concentration on how to better coordinate with other responders and responding agencies. Since the Sep. 11, 2001 terrorist attacks, the magnitude and breadth of planning and responding to disasters has dramatically changed within the United States and around the world. As a result of the Sep. 11, 2001 terrorist attacks, the number of individuals and organizations committed to planning and responding to possible terrorist attacks and their consequences has expanded to include members of the public, private, nonprofit, and not-for-profit sectors in this nation and within the international community. There is a powerful recognition of an interconnection between and interdependence among all sectors related to direct, collateral, and connected impacts from terrorist actions.

Some individuals have reiterated prior assertions that the success of disaster response operations is substantially affected by the achievement of effective inter-organizational coordination among responding groups, including emergency managers, law enforcement, hospitals, public health departments, the military and a host of other organizations embodying a wide range of threat-relevant expertise. In the twenty-first century, emergency response planning and activities are inter-departmental within a jurisdiction and, at the same time, inter-jurisdictional, spawning public-private and intergovernmental teams to address interdependent environmental, public safety, health, infrastructure, and other needs. The current perspective on emergency responsiveness is totally different than that of only a few years ago—managers of police, fire, and ambulance services, as well as mayors, governors and other officials, must now prepare and plan for catastrophic events that were previously unthinkable.

Recent congressional legislation and presidential directives have demanded that a higher level of emergency planning and response be achieved through a comprehensive national approach. There is recognition that terrorists are capable of causing enormous damage to a nation by attacking cities and critical infrastructure (food, water, agriculture, and health and emergency services); energy resources (oil and gas production and refining facilities, electrical generation facilities, and energy distribution networks); transportation systems (air, road, rail, ports, waterways); information and telecommunications networks; banking and finance systems; postal and other assets and systems are vital to our national security, public health and safety, economy and way of life.

The Homeland Security Act of 2002 was the first act to improve prevention, preparedness, response, recovery, mitigation capabilities and coordination processes across the county. On Feb. 28, 2003, the President issued the Homeland Security Presidential Directive (HSPD-5), which directs the Secretary of Homeland Security to develop and administer a National Incident Management System, among other actions. HSPD-8 was issued in 2004 and required a unified all-hazards preparedness that stressed collaboration and coordination at every level of government and in the private sector. The Critical Infrastructure Protection directive (PDD-63) called for a national effort to assure the security of the increasingly vulnerable and interconnected infrastructure. Since the vast majority of a country's critical infrastructure and key assets are owned and operated by the private sector, coordinated relationships and planning efforts are required.

### SUMMARY OF THE INVENTION

The present invention provides for an improved systems-based method for providing members of the public, private, nonprofit and not-for-profit sectors with the ability to collaborate in all aspects of “community” emergency preparedness and response planning. The method of the present invention is embedded within a synchronization matrix process and recognizes the dynamic community interconnectedness and complex interdependence within and among entities, regardless of whether each entity comprises a unit, department, agency, organization, facility, infrastructure, and/or company level, in planning for and responding to all types of hazards, including natural, technological, and terrorist-directed incidents. The present invention can be used by virtually any public and private sector agency and organization world-wide for business practice planning, as well as emergency preparedness and planning for the gamut of natural and technological hazards, including terrorist-directed chemical, biological, radioactive, nuclear, and explosive incidents.

The client-server based software architecture of the present invention provides critical flexibility and adaptability, as well as interoperability in integrating and synchronizing emergency response planning through the use of a novel automated filter system. The filter system fluidly sorts and graphically displays user-selected information regarding locations, sequences, relationships, activity implementers, responsible positions, operational story line, planner notes, resource allocations, activities and other items. The synchronization matrix process of the present invention is an innovative unifying systems-based method with information technology architecture for total emergency management, whether at a site, local, regional, state, national, or international level.

These and other objects, advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a simplified flow chart showing the general synchronization matrix process in accordance with the principles of the present invention;

FIG. 2 is a screen shot showing the visual environment for a computer software program incorporating the principles of the present invention;

FIG. 3 is a representation of a local server topology within which the present invention may be implemented;

FIG. 4 is a representation of a remote server topology within which the present invention may be implemented;

FIG. 5 is a representation of a replicated remote server topology within which the present invention may be implemented;

FIG. 6 is a screen shot of a user's screen for a software program constructed according to the principles of the present invention;

FIG. 7 is a flow chart showing the steps involved in creating and implementing a synchronization matrix according to the principles of the present invention;

FIG. 8 is a screen shot of a jurisdiction screen for a software program constructed according to the principles of the present invention;

FIG. 9 is a screen shot of a library screen for a software program constructed according to the principles of the present invention;

FIG. 10 is a screen shot of a planning set screen for a software program constructed according to the principles of the present invention;

FIG. 11 is a screen shot of a hazard action and decision points screen for a software program constructed according to the principles of the present invention;

FIG. 12 is a screen shot of an activity screen for a software program constructed according to the principles of the present invention;

FIG. 13 is a screen shot of an activity detail screen for a software program constructed according to the principles of the present invention;

FIG. 14 is a depiction showing the animation of a relationship between two activities in a software program constructed according to the principles of the present invention;

FIG. 15 is a screen shot of a thread maintenance screen for a software program constructed according to the principles of the present invention;

FIG. 16 is a screen shot of a layout showing various actions, decisions, events, and other information in an emergency response situation; and

FIG. 17 is a screen shot of a reports screen for a software program constructed according to the principles of the present invention.

### DETAILED DESCRIPTION OF THE PREFERRED EMBODIMENTS

The present invention provides for a synchronization matrix process that comprises a proactive, unifying systems-based method supported by an information technology architecture for total emergency management at site, local, regional, state, national, and international levels. The process of the present invention fulfills a recently recognized critical need for interconnectivity and coordinated relationships among the public, private, nonprofit, and not-for-profit sectors in community preparedness and a coordinated, integrated, and synchronized emergency response.

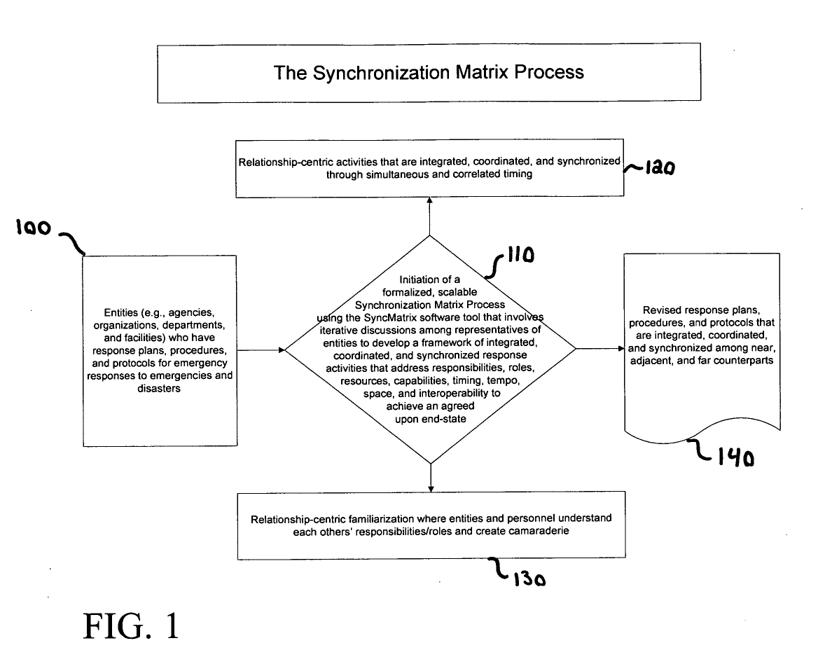

A generic flow chart showing the general nature of the synchronization matrix process of the present invention is depicted in FIG. 1. This process addresses two critical needs that were identified in after-action reports and by researchers looking into the response to the Sep. 11, 2001 terrorist attacks-inter-agency planning and coordination. The process depicted in FIG. 1 fulfills the critical need for interconnectivity and coordinated relationships between the public, private, nonprofit, and not-for-profit sectors in community preparedness and a coordinated, integrated, and synchronized emergency response. During the implementation of the process, the iterative discussions that occur during the development of a framework of response activities using a software tool directly result in a collaborative set of relationship-centric activities (inter-agency planning) and a relationship-centric familiarization among participants (inter-agency coordination and camaraderie). Camaraderie is important because it is beneficial for members of different agencies to get to know one another, thus creating an ability to contact each other discuss issues. Furthermore, when an emergency arises, such camaraderie makes it easier for the respective members to draw on their own prior working relationships to enable multiple agencies to better respond as a “team.”

Step 100 of FIG. 1 involves input from entities such as agencies, organizations, departments, and facilities which possess response plans, procedures, and protocols for emergency responses to emergencies and disasters. At step 110, this input is used to initiate a formalized and scalable synchronization matrix process that involves iterative discussions among representatives of the entities to develop a framework of integrated, coordinated, and synchronized response activities that address responsibilities, roles, resources, capabilities, timing, tempo, space, and interoperability in order to achieve an agreed-upon end-state. This process results in the achievement of relationship-centric activities that are integrated, coordinated, and synchronized through simultaneous and correlated timing, which is represented at step 120. This also results in relationship-centric familiarization, where entities and personnel understand each others' responsibilities/roles and create camaraderie, as represented at step 130. Lastly, this process results in revised response plans, procedures, and protocols that are integrated, coordinated, and synchronized among near, adjacent, and far counterparts, as represented at step 140.

The process centers around an iterative set of discussions that allow entity representatives to agree upon the end-state, think critically as to how to respond to an event, problem solve on interconnectivity and interoperability issues, build a situational understanding, provide an opportunity to consider other options in advance, help simplify complex situations, foster the development of an intuitive sense as to what to expect and how to respond, decipher constraints, organize and task entities and allocate resources, detail cooperation among entities, and guide preparations. During these discussions, the decision makers, whether comprising managers from the lead agency, political leadership, or possible incident commanders, have time to critically think through and collectively create an overarching visualization which entails the intent of action, planning guidance, and critical information needs for decision points. Participants interact to collectively develop and convey a situational understanding to responding to an emergency or disaster with respect to time, space, planning horizons, and flexibility. This is accomplished through a bottom-up approach that involves those who implement a response at a local (municipal, county) level and then layers up the support (capabilities and resources) chain to mutual aid partners, state agencies and departments, regional compacts and entities, and national agencies and departments in order to achieve a robust, fully resourced plan and ensure buy-in by all of the participants of a response.

This layered collective visualization differs from conventional military visualization processes that are hierarchical and involves a doctrinal approach, whereby the leadership envisions a desired outcome, lays out effective ways of achieving it, and delegates to his subordinates the complete planning using insight, creativity, and initiative. At the end of the process, the participants revise their entity's plans, procedures, and protocols based upon the graphical depiction of the present invention, implemented through the use of a computer software program, and accompanying reports of the integration, coordination and synchronization of the activities, breaking out of their planning in isolation.

The software tool of the present invention has the capacity to focus the discussion by serving as a record of decisions for the agreed-upon actions prescribed by the participants and by channeling their discussions to discerning the relationships between each of the actions and the responsible parties or persons. The graphical representation and associated reports present anticipatory planning that reduces the time between the development and implementation of decisions. The tool allows leaders time to assess the potential consequences of their actions and to formulate alternative strategies without the pressures generated by an actual event's immediacy under stressful situations.

The systems-based method of the present invention for emergency preparedness and response planning recognizes the dynamic community interconnectedness and complex interdependencies within and among entities whether at a unit, department, agency, organization, facility, infrastructure, and/or company level in planning for and responding to all types of hazards and terrorist-directed incidents. The systems-based method is a non-sequential approach that relies upon a set of associated components. These components encompass (1) collectively envisioning a broader community concept of operations for planning and responding to hazards that is inclusive of other entities; (2) reviewing and assessing existing plans and procedures of community members; (3) analyzing exercise and after-action reports; (4) performing formal and informal interviews of both emergency agency managers and their personnel and participating private sector organizations and companies; (5) conducting complex problem-solving sessions related to postulated and actual community interactions and resource availability; and (6) concluding with a collaborative interface in a “roll-up” format to validate and synchronize integrating entity actions that were conceived iteratively during the process.

The method discussed herein results in a dynamic bonding and camaraderie among those who would be involved in devising a response through the interlacing of community capabilities and mutual agreement on an outcome. Their continuing interpersonal actions result in their written plans being updated and any future response to a disaster being more effective and efficient. It has been observed that planning in isolation places the plans at risk because many agencies rely upon the same organizations that, in a wide spread disaster, will be quickly overwhelmed. In planning and responding to an emergency, it must be recognized that interactions are idiosyncratic, and relationships are often based upon the politics and personalities that are involved.

The systems-based method of the present invention uses a framework for devolving a large amount of information into a clear and concise graphical presentation with accompanying reports. Relying upon a structure of obvious similarities related to natural and technological disasters, emergency preparedness and response planning efforts can be separated into replicable topical, functional, and/or responsibility categories. A library of these categories that can quickly be accessed ensures the smooth development of a synchronization matrix. The matrix substantially reduces discussions of disparate approaches and builds upon a comprehensive literature base of accepted categories.

Similarly, relying upon a library of relationship-centric actions from past practices that can be imported into a synchronization matrix allows the development of comparative community emergency plans. Both libraries allow planners to select from an array of prescripted materials that are based in experience and validated protocols and practices so that planners do not fall prey to numerous misperceptions and myths that surround emergency planning. Such libraries are not intended to restrict flexibility or adaptations, but to offer guidance and a baseline starting point to begin an emergency response plan that is rooted in industry best practices.

The McKinsey after action report for the Fire Department of the City of New York (FDNY) stated that one of the department's major challenges was to help the city improve its inter-agency planning and coordination. Specifically, it was noted that “the FDNY and other government agencies must improve inter-agency planning and coordination if they are to fulfill their mission to protect the citizens of New York City.” The essential part of systems-based planning is the collaboration that it evokes and requires among entities and parties in defining and integrating actions that affect one another. It has been stated that the shock of a severe disaster in a major city creates a cascade of disruption among interdependent operating systems that shatters the existing functional capacity of the wider metropolitan region.

Knowing and agreeing upon the actions that precede and succeed an integrating action between entities is the critical output of the synchronization matrix and the systems-based method of the present invention. These integrating actions can be tied to hazard actions (i.e., explosions, plume progress, hurricane location, tornado status, etc.) and to decision points so that the timing of response actions within functional areas such as emergency assessment, alert and notification, population protection, victim care, and recovery can be assessed against what needs to be initiated and can minimize community impacts from routine and catastrophic emergencies in the future.

The enabling information technology architecture of the present invention provides a software tool that creates a flexible, adaptable, and interoperable platform for integrating and synchronizing community and entity emergency plans and response actions. A wide range of public and private sector members now recognize the need for collaborative community emergency preparedness and response planning as a result of the interconnectedness between and interdependence among entities whether at a unit, department, agency, organization, facility, infrastructure, and/or company level. All such members must plan for and respond to all types of hazards and terrorist directed incidents.

Information helps to increase the efficiency of response actions and is an essential factor in increasing coordination in disaster management. A software application that provides community planning and response information must provide a graphical user interface that ensures an ease of use. By using Microsoft.NET Framework, for example, the synchronization matrix software tool of the present invention is able to provide a suite of user interface controls that possess a similar look and feel to those popular applications, such as Microsoft Outlook, and achieve instant usability by end users. End users will therefore experience fewer difficulties in learning to use the software, are more at ease with its features due to their daily use of similar applications, and can be more intuitive in its use. Turnover among emergency management and responder personnel places a premium on acquiring tools that possess a reduced learning curve by having interface controls that are common to computer users. The present invention fosters greater acceptability and a higher rate of use that leads to enhanced community preparedness and an efficient response to any hazard.

The architecture of the synchronization matrix software tool of the present invention embraces a number of features that enhance its application and use. First, the tool is user friendly. By having the tool look and operate in a manner similar to common graphical user interfaces, a more intuitive feel is provided in its use by the target user community. A significant problem with new software applications has always involved the training required and the frequency of use necessary to be able to implement the interface to its full extent and capability. By using a system such as NET, the software tool provides a suite of controls that are known to most computer users and often used on a daily basis.

The software tool of the present invention also provides for an automated filter system. A novel automated filter system is embedded in the software tool that fluidly sorts and graphically displays user-selected information as to location, relational threads, activity implementers, responsible positions, operational story lines, planner notes, resource allocations, and activities. This filter provides users with a quick means to identify key elements of the planning process and response, not only for their own entity, but also for other integrating predecessor and successor actions.

Emergency planning often requires the use of sequencing to describe procedures and practices so that actions can be understood, and bottlenecks and delays can be mitigated and/or removed to enhance a response. Sequencing is performed devoid of actual time. The software tool of the present invention provides the ability to visualize and graphically display the sequence of actions.

In addition, the tool of the present invention also enables the creation of relationship-centric action threads. Activities do not exist in a vacuum. Each action is tied to other elements (e.g., a situation generated by the hazard, a decision point, or a response action) as a predecessor or successor and is sequential or concomitant in their timing. The tool of the present invention makes these relationships explicit in terms of an ability to manage and control them. Through the ability to create libraries of relationship threads, end users can quickly replicate sets of actions within their community planning efforts that are identical and based upon experience, federal guidelines, state and local policies and procedures, or other entity directives. The use of replicable relationship-centric threads in achieving commonality of planning and response significantly increases the viability and validity of an interconnected plan and response.

The software tool of the present invention also provides the ability to graphically display and report on the individual actions of each implementer unit (e.g., department, agency, organization, floor, station, shelter, school, precinct, etc.) and responsible party (e.g., chief, chairperson, elected or appointed official, director, dispatcher, operations, incident commander, shelter manager, etc.) by action. This functionality allows a planner to determine action loading. Paper plans and procedures provide lists of actions to be undertaken by an implementer unit and responsible party without any sense of their timing and potential surges in actions. The software tool's capability resolves this common problem that often hides the potential for plan and response dysfunction.

The software tool of the present invention is also client-server based. The synchronization matrix information technology architecture relies upon client-server architecture in order to better support collaborative planning and response. The process of collaboration in the planning process reduces the fragility of a response. A client-server based architecture and protocols for sharing plans within a community and knowing the integrating predecessor and successor actions from others' plans are critical to reducing the prospect of spreading dysfunction during a response to an emergency.

Lastly, the software tool of the present invention is also minimally invasive in comparison to prior systems. The process of developing an emergency response plan is an iterative one. At any point in time, the planner may be missing a vast amount of information that is ultimately necessary to “complete” the plan. The synchronization matrix architecture of the present invention ensures that the application runs with as much or as little information as a planner has at any time, as opposed to rigidly requiring all of the information up front. As more information becomes available to the planner, it can be entered into their matrices, and resulting changes can be reflected throughout the entire plan.

The software of the present invention also provides two libraries to assist users in developing comparative community plans. First, there is a library of replicable topical, functional, and/or responsibility categories based upon federal agency guidance and emergency literature experience with the flexibility to construct additional libraries based on new environments for later reuse. These libraries can easily be adapted to the private sector. For example, a library that is specific to hospitals can be used. Second, there is a reusable library of relationship action threads from past planning and response practices (e.g., evacuation, decontamination, alert and notification, facility sheltering in place, traffic control point establishment, shelter admission, hospital admission, placement of security, and medical screening) that can be imported into new plans, thereby promoting the development of comparative community emergency plans and responses. Both libraries allow planners to select from an array of prescripted materials that are based in experience and validated protocols and practices so that planners do not fall prey to numerous misperceptions and myths that surround emergency planning. Such libraries are not intended to restrict flexibility or adaptations, but to offer guidance and a baseline starting point to begin an emergency response plan that is rooted in industry best practices.

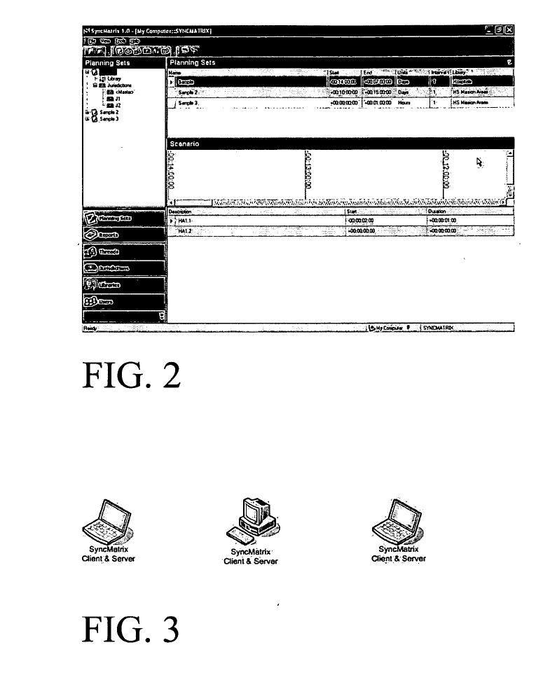

FIG. 2 is a screen shot showing the general visual environment for a computer program product constructed according to one embodiment of the present invention. In this embodiment, the left-most pane shows the server explorer while the right-most pane is used to show the currently active page. Graphics show the server explorer, page references, menus, toolbars, the server/site connectivity, and the status bar. The interface also shows small spreadsheets or grids that provide a mechanism for quickly reviewing data. The grid is divided into rows, which depict entire data records, and columns, which comprise particular pieces of data.

The server explorer provides high-level navigation within the visual environment. It provides an at-a-glance overview of the major elements of the current site with which the users are interacting. The server explorer is broken down by topical areas within the site. Each of these areas is identified by a separate tab within the server explorer. In one embodiment of the invention, these tabs are as follows:

Planning Sets. A planning set represents a particular emergency. It defines a scenario, comprising one or more hazards involving one or more jurisdictions which must respond to the emergency and a library. The library is used to define the major functional areas within the response. Each jurisdiction ultimately produces a matrix, which describes the response to the emergency described by the planning set.

Reports. The reports tab provides several pre-defined reports that can be used to generate a printable record of the emergency response activities.

Threads. The threads tab provides access to the various threads that have been defined within the site. A thread is a reusable collection of activities and their relations. This allows one to produce a specific sequence of activities within a matrix, turn those activities into a thread, and reuse them in different planning sets.

Jurisdictions. The jurisdictions tab provides the format for defining the various jurisdictions, departments, and positions that might be involved in a planning set.

Libraries. Libraries are reusable combinations of mission areas and functions that are used to describe the functional aspects of an emergency response.

Users. Users are the individuals who have been granted access to the data within the site. This tab provides access to the users themselves, as well as their security information. Only site administrators are allowed to access the information on this tab in one embodiment of the invention.

In order to access a particular area of the software application, the user clicks on the appropriate tab within the server explorer. The right-hand side of the screen will change to show the details for that particular topical area. For example, clicking the planning sets tab will display the planning set maintenance page. Similarly, clicking the jurisdictions tab will show the jurisdiction maintenance page. One can change to any page at any time; no particular sequence need be followed. The various tabs each contain their own view of the data.

A complementary navigation approach to assist in viewing the data and traversing the environment is the “tree.” By selecting the planning set tab within the server explorer, the planning sets are shown within a tree, with planning set branches expanded. By interacting with this tree, control is granted over which page of information is to be displayed in the main region of the application.

In contrast to prior conventional systems, the application provides the ability to have planners from multiple jurisdictions working simultaneously on a single “community” planning matrix. In addition, the application provides the “master” matrix, which allows a planner to review the complete emergency response plan from all of the participating jurisdictions together in a single matrix. This provides a “big picture” view of the overall response and can allow a planner to zero in on problems or discrepancies that might not be immediately obvious from reviewing the individual matrices.

The application is divided into two separate components: the client and the server. The client is the graphical look-and-feel with which the user will interact. The server is where the application stores its data. The data itself is stored within a site on that server. The application allows three topologies or configurations of the client and the relationship to the server to support planning efforts: remote server, local server, and replicated remote server.

In a local server topology, the client and server are installed on the same machine. This is the way that the software is installed by default in one embodiment of the invention. This means that a user can always use the software, even if they do not have a remote server on which to store their data. The topology for this arrangement is shown in FIG. 3.

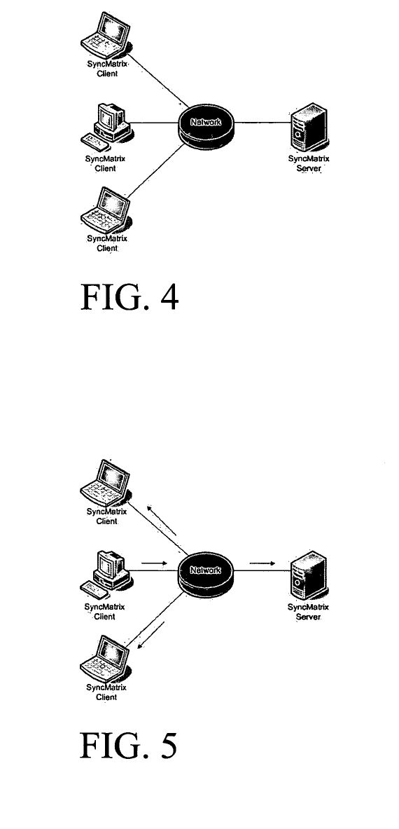

The second topology is the remote server topology. This particular topology is illustrated in FIG. 4. In this topology, one or more clients coordinate with a centralized server that is responsible for maintaining all of the client's data. This is a common approach when one or more emergency response plans need to be shared by different users. For example, each user could have the software installed on their local machine, while their data is stored in a site on a common file server. The remote server topology requires that the client be able to contact the server through a network. This topology can be useful when all of the clients are co-located and part of the same network.

In theory, there is no difference in the use of the application, regardless of whether or not the user is accessing a local or remote server and site. In practice, the only difference is that, in order to access a remote server and site, the client must be able to access the network on which that site is stored.

The third topology, as shown in FIG. 5, is the replicated remote server topology. This topology combines the benefits of the remote and local server topologies by allowing a user to define a local server that contains a copy of the data that resides on a remote server. As the data changes on the remote server, that data is transmitted or replicated to the local server. As changes are made to the local server, those changes will be replicated back to the remote server. This topology is useful for users that wish to make changes to some shared plans but may not have access to a reliable network all of the time. For example, this technique could be used to work on a matrix while the user is on a plane, or when in a hotel that does not provide adequate Internet access. By replicating the data from the remote server to a local server, a user gets an initial copy of the data. The user can then manipulate the local copy of the data. When the network becomes available, those changes will be synchronized back to the remote server, and any changes that were made to the remote server will be incorporated into the local server.

The application can be configured to support all three topologies at once without stopping and restarting the software. Therefore, a user can work with some of the emergency response plans in a strictly local server topology, work with shared data using a remote server and maintain a local replicated copy of a remote site all at once.

Once a server and a site have been configured to the software, work can begin with the tool. However, there may come a time when a user might wish to secure the data within one or more of the sites. The software can assist the user in the design and implementation of such a security strategy.

In addition to other benefits described herein, the software posseses a high level of security. The software uses role-based security, which defines three roles within the software: administrator, author and reviewer. Users may be assigned one or more of these roles. In turn, the software is configured to allow or disallow access to certain capabilities of the software to the various roles.

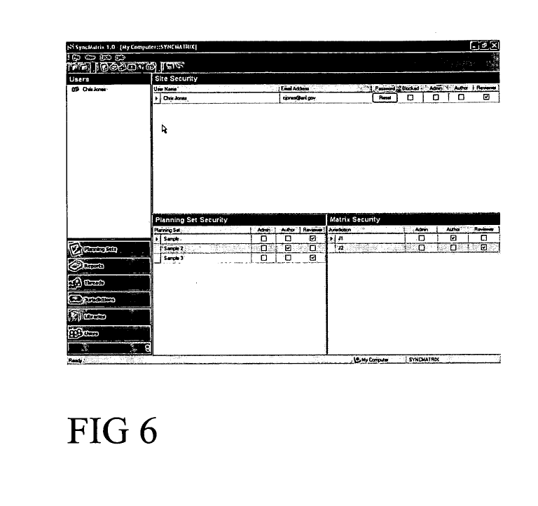

All user maintenance tasks for the software take place on the user's page. This page can be activated by selecting the users tab in the server explorer as shown in FIG. 6. This page is divided into three regions. The first region, referred to as “Site Security,” allows an administrator to configure and maintain the basic user information for the site. It also allows a site administrator to configure the site-level security on a per-user basis. The “Planning Set Security” region allows an administrator to configure which users have which roles within a given planning set. Finally, the “Matrix Security” region allows an administrator to define the roles of a user on a per-matrix basis within a given planning set.

In one embodiment of the invention, the software allows for two additional levels of security to be defined for a given user: planning set and matrix. The planning set security involves granting the user a set of roles on a per-planning set basis. Similarly, the matrix security set allows the administrator to grant a set of user-specific roles on a per-matrix basis within a planning set. Therefore, a user might be a reviewer in one matrix, but an author in another within the same planning set. Similarly, a user could be an administrator or author of a planning set, thereby giving the user the ability to work with any matrix within that planning set, while only being a reviewer in another planning set.

Each activity record has a location where responsibility is assigned to a department, agency, or organization for its implementation, as well as the position or individual who is tasked with that action. The increased level of detail provided decreases the uncertainty and error which can occur in a plan or response, and leads to an identification of deficiencies.

The software application has the versatility to be used by a wide-range of government and nongovernmental entities in emergency planning. These entities include, but are not limited to, corporate emergency and safety departments; volunteer, non-profit, and not-for-profit organizations and agencies, state and county offices and departments; law enforcement, fire protection departments and organizations; medical facilities and the medical community; regional organizations involved with emergency planning; federal emergency planning or homeland security entities with National Response Plan roles; and the international community and their respective emergency planning and response departments and agencies.

The decision-making ability of the application allows users to know if a decision must be made and when, as well as whether or not that decision should or could be based on relationships between hazard actions. Decision points can involve a point in time when a course of action must be ordered or announced, such as, the initiation of an evacuation or sheltering at a school because of negative events, the opening of a pharmaceutical cache to dispense needed prophylactic medicines to affected or at risk persons, the establishing of roadblocks to halt or divert traffic, or the setting up a decontamination facility to accommodate those who might have been affected. Hazard actions are the times of release and movement of a hazard. Actions can involve a wide array of actions that relate to a hazard action or a decision point, such as dispatching buses to evacuate school children, providing a briefing on the situation, performing alert and notification through outdoor warning sirens, relocating patients off of a hospital floor, dispatching police vehicles to establish a roadblock, distributing pharmaceuticals to responders, or other items. Actions have relationships that are correlated, i.e., where one activity does not depend on the completion of another activity, or sequential, i.e., where one activity follows another activity in timing.

The software tool provides an inter-jurisdictional link, which is a logical association between two activities in two different matrices within the same planning set. Links between two matrices are reflected using a drop-shadow that denotes the state of the link. Each planner has complete control over their own matrix and can make any changes that they wish without fear of introducing problems into any other matrices. At the same time, discrepancies between different views of the same activity are immediately apparent and can be discussed and reconciled as needed.

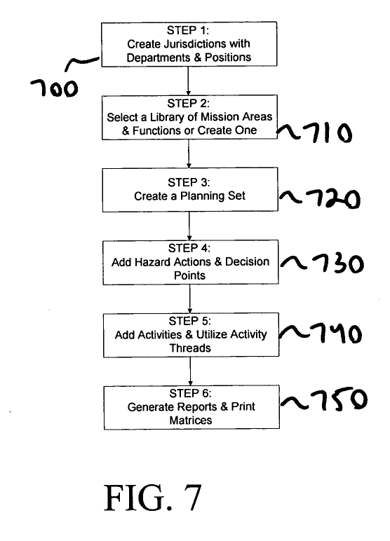

According to one embodiment of the invention, the tool includes a sequence of steps that are to be performed in the creation of any Synchronization Matrix. FIG. 7 shows the six steps that are used to create a matrix once the software has been installed on a server or a stand alone computer. The synchronization matrix process is initiated before the tool is applied. During the process, the jurisdictions, departments and positions are identified, and the mission areas and functions are determined prior to creating the planning set that is to be worked by the participating planners.

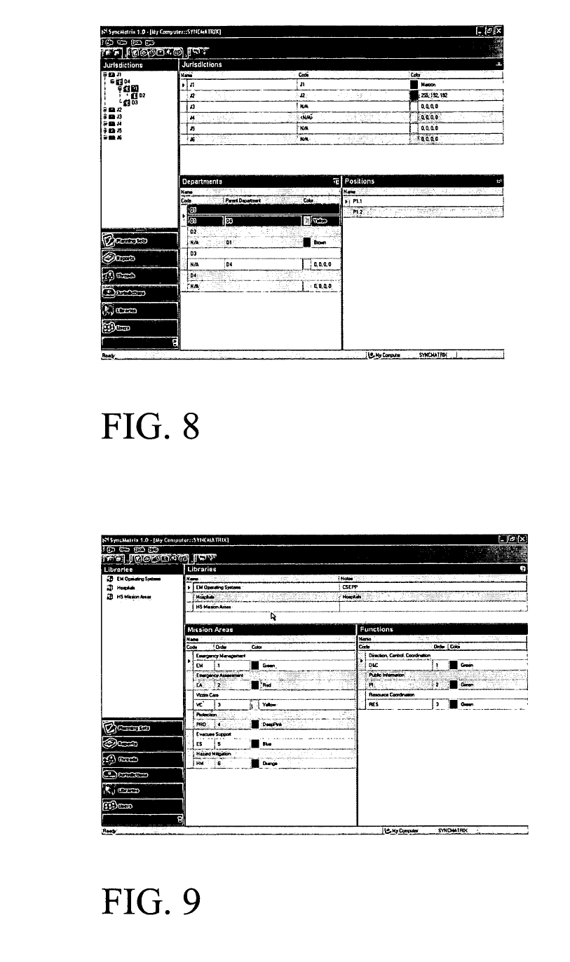

Step 700 in FIG. 7 involves the creation of jurisdictions including the identification of jurisdictions, departments and other entities. The proper identification of jurisdictions, departments and positions can greatly facilitate communication during the emergency planning process as well as during the actual emergency response. FIG. 8 shows the jurisdiction tab with information relating to the jurisdictions, departments, and positions available for selection to a planning set. The system of the present invention can re-use the jurisdictions, departments and positions across multiple planning sets.

Step 710 in FIG. 7 involves the selection or creation of a library of mission areas and functions. The software provides a user with the ability to make a selection of a library comprising a set of mission areas and functions for a planning set, or the development of a planning-set specific library. A screen shot showing this process is depicted in FIG. 9. Each library is a composite of mission areas, which are broad categories of functional areas, and functions, which are more defined categories within a functional area. The selection of an existing library indicates the adoption of a standard set of mission areas and functions. This helps to ensure that consistent terminology is used throughout the planning process and across all of the jurisdictions involved in that process.

It is possible to add a new library to a site. An alternative is to customize an existing library for use in a given planning set.

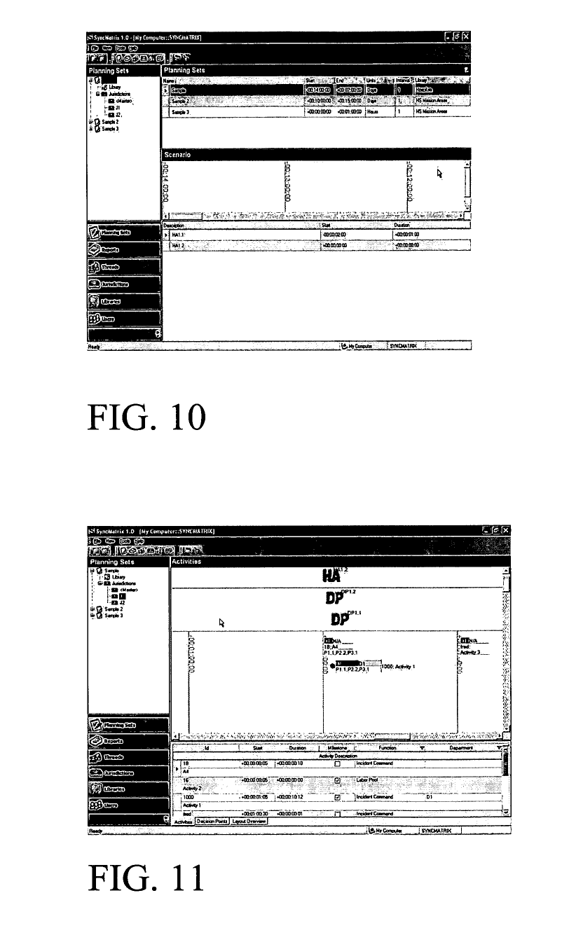

Step 720 in FIG. 7 involves the creation of a planning set. A planning set describes an emergency that comprises a scenario. Each scenario is essentially a story that describes a sequence of hazard actions or events that unfold and serve to describe the nature of the emergency that is anticipated and being planned for. The planning set tab is shown in FIG. 10.

Step 730 in FIG. 7 involves the adding of hazard actions and decision points. Hazard actions and decision points are key factors in planning a response. FIG. 11 shows the screen in which hazard and decision points are displayed. The software requires that the hazards being planned for are defined and recorded as to occurrence, timing and duration, in the planning set through the placement of the specific hazard actions that display the evolving event scenario.

Decision points are locations where a decision must be made to have an optimal effect on achieving the desired course of action and end-state. Decision points are the keystones for relationships among actions that follow each decision. Decision points are added to each jurisdiction once the hazard actions are identified and placed in the planning set.

Step 740 in FIG. 7 involves the addition of activities and utilization of activity threads. The matrix of activities is the heart of the synchronization matrix planning process record. Once a planning set has been defined that specifies the scope of the emergency in the form of a scenario and identifies the jurisdictions that will participate in the response, those jurisdictions can begin to construct their planned response. In creating the planned response, participants readily identify and then seek to resolve interoperability and activity relationship issues.

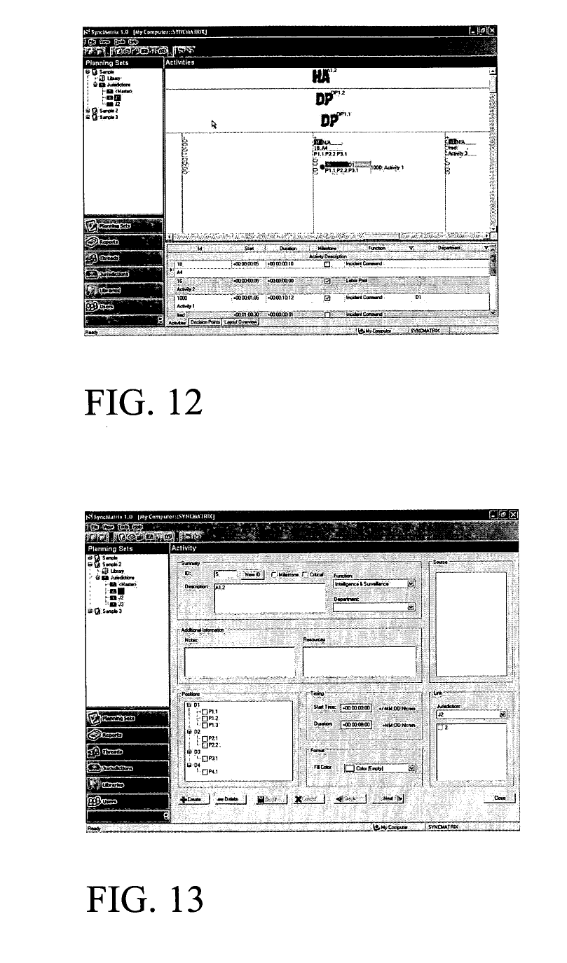

Matrices are built using the activity view, which is shown in FIG. 12. This page is divided into two major regions: the matrix graph region at the top of the page and the matrix grid region at the bottom of the page. The graph region provides a graphical view of the hazard actions, decision points, activities and relations that comprise the matrix. The details of the activities and decision points are available in the matrix grid region. Both regions can be used to create new activities or decision points. In addition, the graph region can be used to create relationships between activities, decision points and hazard actions. The matrix grid region can be used to view and change more details of the activities and decision points than is possible with the graph region.

While the activity graph and grid provide a way for quickly reviewing the most common aspects of an activity, they do not provide all of the information that is available about an activity. In order to view all the details about an activity, a user can open the Activity Detail page, depicted in FIG. 13, to have the ability to review and change all aspects of an activity, including those aspects that can be manipulated in other locations within the tool, such as via the grid and graph.

The activity detail page is broken down into two groups (a summary group and an additional group) of related information. The summary group describes high-level information about the activity or milestone, including the unique identifier, a full text description, whether an item constitutes an activity or milestone, the determination of its criticality in a response, the library function, and departments within a jurisdiction that own the activity or milestone. The additional information group comprises supporting information that includes notes and resources, the source of the information, the position responsible for the activity, timing as to start and duration, the format as to fill colors, links to jurisdictions that create inter-jurisdictional relationships, and similar items.

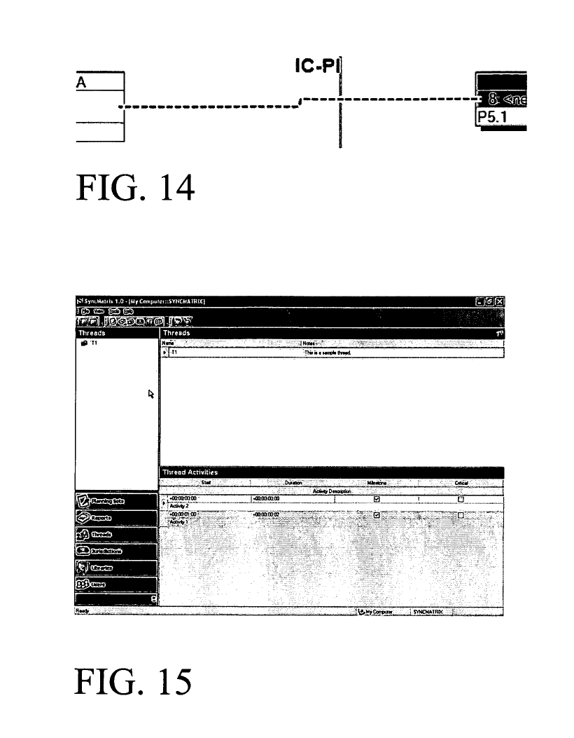

The application described herein provides a significant improvement over conventional systems in the ability to create inter-jurisdictional links and to display them on a single master matrix view. A hybrid approach offers the option of duplicating an activity within matrices or sharing activities within individual jurisdiction matrices. An inter-jurisdictional link is a logical association between two activities in two different matrices within the same planning set. A linked activity will appear in the matrix as having a drop-shadow at its bottom-right and the color of the drop-shadow reveals the status of the link and the activities. The relationship between two activities can also be animated, so that the relationship appears to move between its source and its target as events occurred. This is depicted in FIG. 14.

Another significant improvement offered by the present invention is the ability to filter the activities for viewing based upon various conditions. The filtering capability includes an ability to filter by department. Filtering does not actually remove or delete activities from the matrix, but instead simply selectively hides those related activities the user does not want or need to view at a given moment.

A further improvement offered by the present invention is the use of a thread builder. A thread is a named collection of activities (e.g., performing decontamination, establishing a shelter, evacuating a school, performing triage, and setting up traffic control points) and their associated relationships. If a sequence of steps almost never changes for the collection of activities, no matter the emergency response to which they belong, it can get quite tedious to keep entering the activities and relationships. Therefore, these related activities and relationships can be saved as a unit and are independent of the matrix from which they were originally drawn. Once created, these threads can be imported into an existing matrix. This re-creates the activities and relationships that comprise the thread in the matrix, thus allowing the user to avoid unnecessary typing and entering of information.

Threads are administered through two different pages: the thread maintenance page and the thread builder page. The thread maintenance page is used to define the basic characteristics of a thread and to review the contents of that thread. This page can be accessed from the thread tab on the server explorer and is shown in FIG. 15.

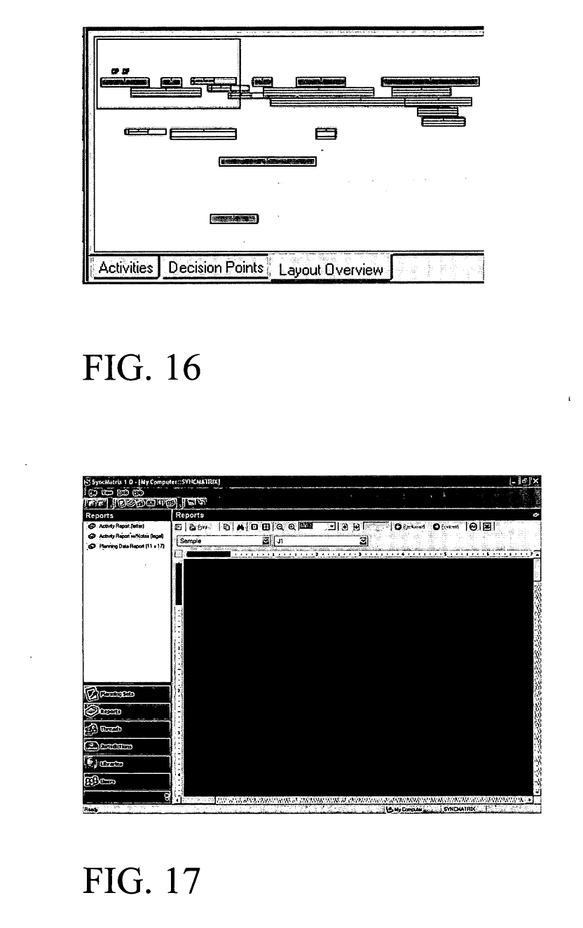

Matrices can become extremely large and complicated. This can make it difficult to quickly and easily find a specific area of the matrix. The present invention offers an improved capability in its layout overview by allowing a view of the whole matrix in a screen, where a user can navigate around the view and then zoom in to specific portions of the matrix that have been targeted. Such a layout overview is depicted in FIG. 16.

Step 750 in FIG. 5 involves the generation of reports and printing of matrices. The present invention provides users with the ability to generate several reports with varying information, as well as the ability to print the entire matrix, either as multiple pages or as a single print created on a plotter. Through the use of the reports tab in the server explorer, which is depicted in FIG. 17, the initial form of the reports page identifies the three standard report formats available for viewing or printing. The various controls within the reports page provide a wealth of capabilities for reviewing and formatting reports, including expanding and hiding items located in the contents panel. Printing a hard copy can be particularly useful when meeting with other planners to strategize and resolve any issues that have arisen during the planning process.

The present invention is described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module,” as used herein and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A computer program product for providing coordinated information among a plurality of entities in response to an emergency situation, comprising:
computer code for storing a plurality of information items relating to emergency responses, the information items being selected from the group consisting of planning sets for an emergency, individual activities to be undertaken in response to an emergency, decision points required in an emergency response, relationships among activities and decision points, jurisdictions involved in an emergency response, agencies involved in an emergency response; users that have been provided access to emergency response information within the computer program product and combinations thereof;
computer code for enabling the receipt of information items from a plurality of users regarding a coordinated response to an emergency situation;
computer code for enabling the compiling of the plurality of information items into an emergency response matrix; and
computer code for selectively exhibiting portions of the emergency response matrix on at least one user interface based upon predefined criteria.

2. The computer program product of claim 1, further comprising computer code for enabling the printing of selected portions of the emergency response matrix based upon the predefined criteria.

3. The computer program product of claim 1, further comprising computer code for designating individual actions as being completed based upon input from at least one user.

4. The computer program product of claim 1, wherein the selective exhibition of portions of the emergency response matrix comprises exhibiting those portions of the plan that relate to a particular user.

5. The computer program product of claim 1, wherein the selective exhibition of portions of the emergency response matrix comprises exhibiting those portions of the plan that relate to a particular jurisdiction.

6. The computer program product of claim 1, wherein the selective exhibition of portions of the emergency response matrix comprises exhibiting those portions of the plan that relate to a particular action.

7. The computer program product of claim 1, wherein the selective exhibition of portions of the emergency response matrix comprises exhibiting those portions of the plan that relate to a particular agency.

8. The computer program product of claim 1, further comprising computer code for storing a plurality of libraries of mission areas, each of the mission areas including selected information items for use in an emergency response.

9. The computer program product of claim 8, wherein the plurality of libraries are customizable by a user.

10. The computer program product of claim 1, further comprising computer code for storing a planning set describing a scenario of hazard events that occur during a particular emergency.

11. The computer program product of claim 1, further comprising:
computer code for storing a plurality of threads, each of the plurality of threads comprising a sequence of related actions that do not substantially change in response to a particular hazardous event; and
computer code for selectively incorporating individual threads into the emergency response matrix.

12. The computer program product of claim 11, further comprising computer code for enabling a user to create threads for storage and use in the computer program product.

13. A computer program product for assisting in the implementation of a coordinated and comprehensive emergency response plan, comprising:
computer code for storing jurisdictional information regarding jurisdictions, departments and positions that are to be involved in the response plan;
computer code for storing a library of mission areas relating to functions associated with the response plan;
computer code for creating a planning set describing an emergency situation;
computer code for adding a plurality of hazard actions and decision points relating to the emergency situation to an emergency response matrix;
computer code for adding a plurality of response activities to the emergency response matrix, each of the response activities being associated with at least one jurisdictional entity for use in planning a response; and
computer code for enabling associated jurisdictional entities to add information concerning the entity's planned response with respect to their associated activities.

14. The computer program product of claim 13, further comprising computer code for selectively exhibiting portions of the emergency response matrix on at least one user interface based upon predefined criteria.

15. The computer program product of claim 13, further comprising computer code for designating individual actions as being completed based upon input from at least one user.

16. The computer program product of claim 14, wherein the selective exhibition of portions of the emergency response matrix comprises exhibiting those portions of the matrix that relate to a particular user.

17. The computer program product of claim 14, wherein the selective exhibition of portions of the emergency response matrix comprises exhibiting those portions of the matrix that relate to a particular jurisdiction.

18. The computer program product of claim 14, wherein the selective exhibition of portions of the emergency response matrix comprises exhibiting those portions of the matrix that relate to a particular action.

19. The computer program product of claim 14, wherein the selective exhibition of portions of the emergency response matrix comprises exhibiting those portions of the matrix that relate to a particular agency.

20. The computer program product of claim 13, further comprising computer code for enabling a plurality of users from accessing and modifying the matrix from remote locations.
